(19) United States
(12) Patent Application Publication
(10) Pub. No.: US 2026/0116904 A1
(43) Pub. Date: Apr. 30, 2026

(54) SILOXANE FUNCTIONALIZED PLATINUM OXALATE COMPLEX

(71) Applicants: DOW SILICONES CORPORATION, Midland, MI (US); DOW GLOBAL TECHNOLOGIES LLC, Midland, MI (US)

(72) Inventors: Mary E. Garner, Midland, MI (US); Souvagya Biswas, Midland, MI (US); Matthew Jeletic, Freeland, MI (US); Bizhong Zhu, Midland, MI (US); Jonathan Axtell, Sanford, MI (US)

(21) Appl. No.: 19/477,627

(22) PCT Filed: Apr. 17, 2024
(86) PCT No.: PCT/US2024/024849

§ 371 Date: Oct. 22, 2025

Related U.S. Application Data
(60) Provisional application No. 63/465,287, filed on May 10, 2023.

(51) Int. Cl. C07F 15/00

(52) U.S. Cl. CPC C07F 15/0013

(57) ABSTRACT

The present invention is platinum(II) oxalate compound of the following formula: where R¹, R², and R³ are as defined herein. The platinum(II) oxalate compound of the present invention is useful as a catalyst in hydrosilylation reactions, especially the hydrosilylation of curable siloxanes.

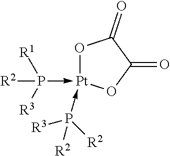

### BACKGROUND OF THE INVENTION

The present invention relates to a compound which is a platinum oxalate complex functionalized with siloxane groups, more particularly, functionalized with phenyl groups substituted with siloxane groups. The compound is useful as a catalyst for hydrosilylation reactions.

Platinum catalysts are used to promote the hydrosilylation of organohydrogenpolysiloxanes (Si—H containing siloxanes) with vinyl-functionalized siloxanes. UV-initiated hydrosilylation reactions are especially desirable due to the low energy input required to initiate reaction. Presently, two platinum compound families are being used commercially for this purpose: cyclopentadienyl trialkyl platinum(IV) (CₚPtR₃), and platinum(II) acetylacetonate (Pt(acac)₂).

The most common CₚPtR₃ catalysts—cyclopentadienyl trimethyl platinum(IV) and methylcyclopentadienyl trimethyl platinum(IV)—have limited solubility in common siloxane polymers and are too volatile for applications that require thin coatings.

Pt(acac)₂ also has limited solubility in siloxane polymers and promotes hydrosilylation even more slowly than CₚPtR₃ catalysts; moreover, the dark stability of formulations containing Pt(acac)₂ is relatively poor.

Accordingly, there is a need in the field of UV triggered hydrosilylation of polysiloxanes to improve the solubility and cure efficiency of platinum-based catalysts.

### SUMMARY OF THE INVENTION

The present invention addresses a need in the art by providing a platinum(II) oxalate compound of the following formula:

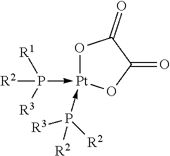

where R¹ is phenyl(CH₂)ₙR⁴, where n is from 3 to 30; each R² is independently C₁-C₁₀-alkyl, phenyl, or phenyl(CH₂)ₙR⁴; each R³ is independently C₁-C₁₀-alkyl, phenyl, phenyl(CH₂)ₙR⁴, or each R³, together with the phosphorus atoms to which they are attached, form a diphosphine; each R⁴ is either:

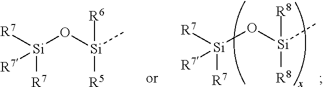

where R⁵ is C₁-C₁₀-alkyl or phenyl; R⁶ is C₁-C₁₀-alkyl or phenyl or O—Si(CH₃)₃; each R⁷ is independently C₁-C₁₀ alkyl or phenyl; R^{7′} is C₁-C₁₀ alkyl; and each R⁵ is independently C₁-C₁₀-alkyl or phenyl; x is from 2 to 250; and the dotted line represents the point of attachment to a CH₂ radical.

The compound of the present invention is useful as a catalyst in hydrosilylation reactions, especially the UV-triggered hydrosilylation of curable siloxanes.

### DETAILED DESCRIPTION OF THE INVENTION

The present invention is a platinum(II) oxalate compound of the following formula:

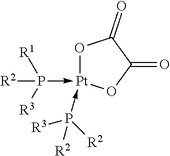

where R¹ is phenyl(CH₂)ₙR⁴, where n is from 3 to 30; each R² is independently C₁-C₁₀-alkyl, phenyl, or phenyl(CH₂)ₙR⁴; each R³ is independently C₁-C₁₀-alkyl, phenyl, phenyl(CH₂)ₙR⁴, or each R³, together with the phosphorus atoms to which they are attached, form a diphosphine; each R⁴ is either:

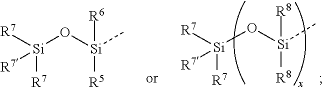

where R⁵ is C₁-C₁₀-alkyl or phenyl; R⁶ is C₁-C₁₀-alkyl or phenyl or O—Si(CH₃)₃; each R⁷ is independently C₁-C₁₀ alkyl or phenyl; R^{7′} is C₁-C₁₀ alkyl; and each R⁸ is independently C₁-C₁₀-alkyl or phenyl; x is from 2 to 250; and the dotted line represents the point of attachment to a CH₂ radical.
R⁵ is C₁-C₁₀-alkyl or C₁-C₆-alkyl or methyl or phenyl; R⁶ is C₁-C₁₀-alkyl or C₁-C₆-alkyl or methyl or phenyl or O—Si(CH₃)₃; each R⁷ is independently C₁-C₁₀ alkyl or C₁-C₆-alkyl or methyl or phenyl; R^{7′} is C₁-C₁₀-alkyl or C₁-C₆-alkyl or methyl; n is from 3 or from 4 to 30 or to 20 or to 10; where R⁸ is independently C₁-C₁₀-alkyl or C₁-C₆-alkyl or methyl or phenyl; x is from 2 to 250 or to 100 or to 50 or to 20 or to 12.

Examples of phosphine ligands are illustrated:

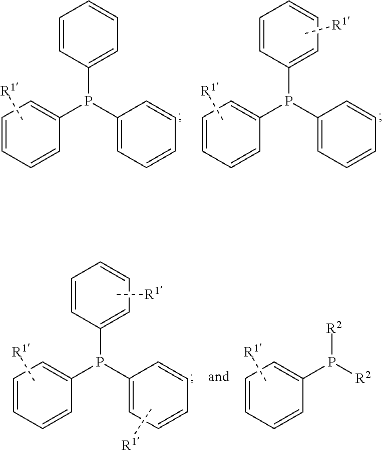

where each R^{1′} is independently (CH₂)ₙR⁴. Examples of R² groups include methyl, ethyl, propyl, n-butyl, n-hexyl, n-octyl, and n-decyl.

The R³ groups, together with the phosphine atoms to which they are attached may form a diphosphine, for example:

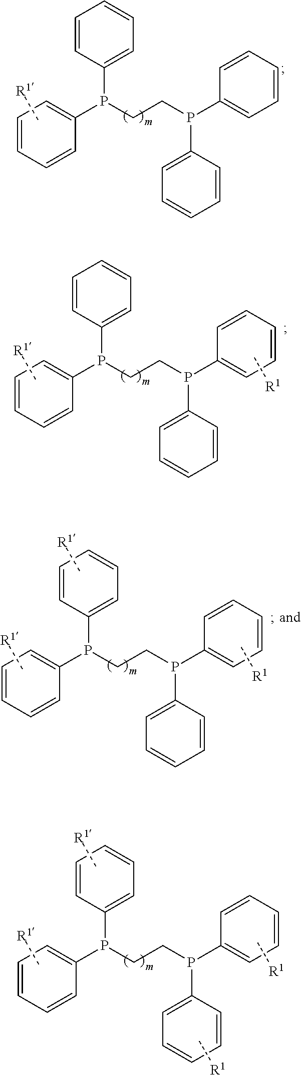

where m is 0, 1, 2, 3, 4 or 5.

The following reaction schemes illustrate the preparation of monophenylsiloxy-, bis(phenylsiloxy)-, and tri(phenylsiloxy) phosphine ligands:

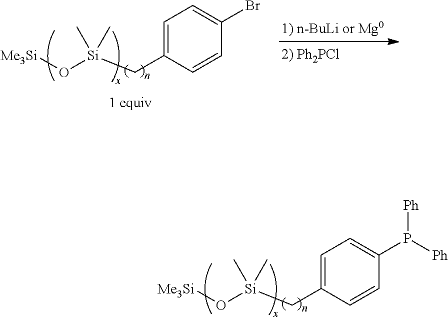

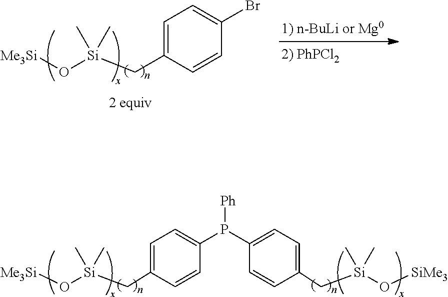

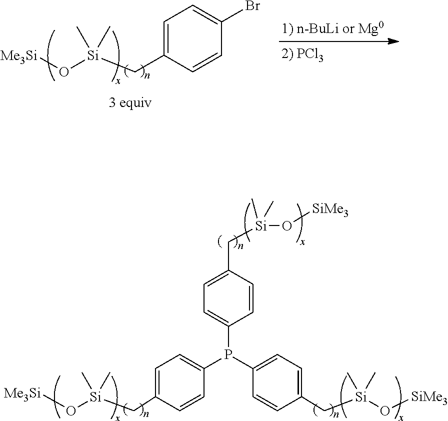

Mono- and bis(phenylsiloxy)diphosphines can be prepared as follows:

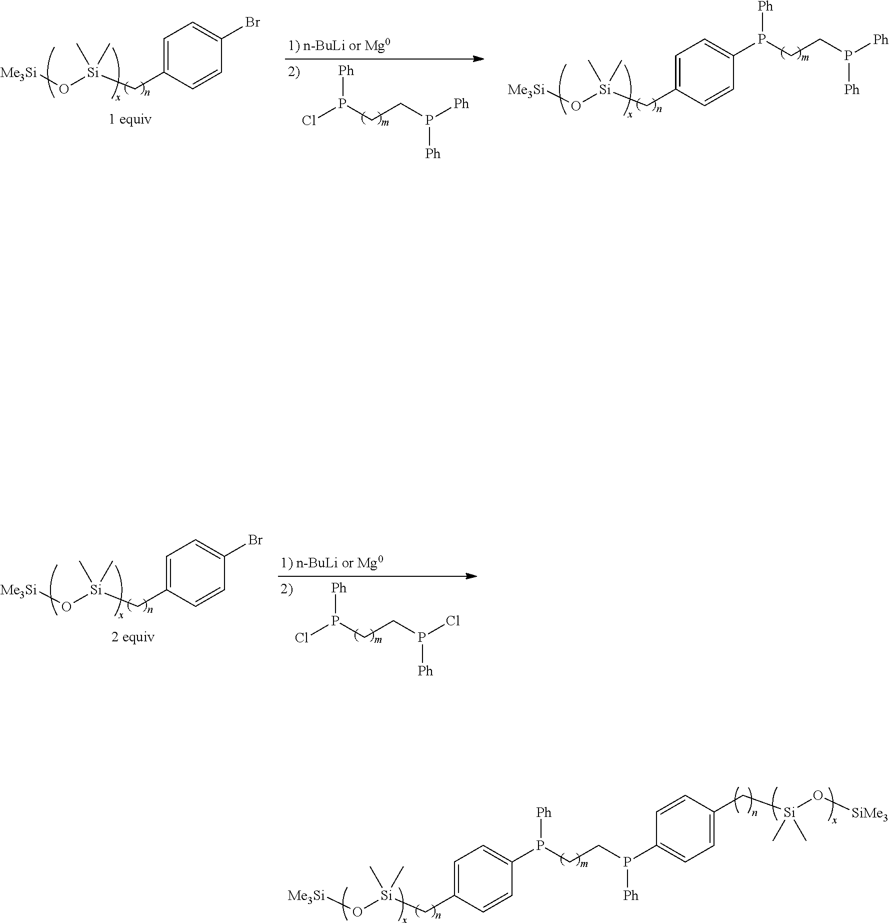

The bromophenylsiloxane starting material can be prepared by the following scheme:

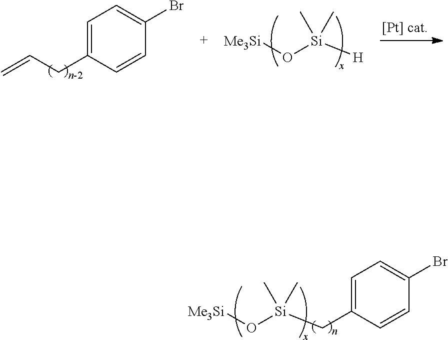

The platinum oxalate compound of the present invention can be prepared by reacting the phosphine ligand with a dipotassium platinum(II) oxalate in accordance with the procedure described in WO 2005/051996. The general scheme is as follows:

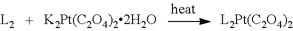

where L is the phosphine ligand.

The compound of the present invention is useful as a catalyst that improves the reaction efficiency between a vinylsiloxane and a silane under UV light at ambient temperature. Moreover, the mixture of the reagents and the catalyst exhibits good to excellent dark stability, that is, relative stability against undesired reaction under conditions of non-exposure to UV light.

### Examples

### Intermediate Example 1—Preparation of 1-Bromo-4-(but-3-en-1-yl)benzene

4-Bromobenzyl bromide (10.0 g, 40.01 mmol, 1 equiv) was dissolved THF (25 mL) then cooled to 0° C. Allylmagnesium bromide (44 mL, 44.01 mmol, 1 equiv) was then added slowly by syringe. The solution was allowed to warm to ambient temperature with continued stirring for 20 h. The reaction mixture was then carefully quenched with water. A solution of brine (100 mL) was added to the quenched mixture, which was stirred for 10 min. The organic phase was washed with brine and dried over MgSO₄. The solvent was removed in vacuo affording an oil. The crude material was then subjected to ISCO column chromatography on silica (100% hexanes). The final product was recovered as a colorless oil. Yield: 5.08 g, 60.1%. ¹H NMR (400 MHz, CDCl₃) δ 7.47-7.36 (m, 1H), 7.10-7.02 (m, 1H), 5.93-5.68 (m, 1H), 5.13-4.91 (m, 1H), 2.75-2.61 (m, 1H), 2.42-2.24 (m, 1H). ¹³C NMR (101 MHz, CDCl₃) δ 140.9, 137.7, 131.4, 130.3, 119.7, 115.4, 35.4, 34.9.

### Intermediate Example 2—Preparation of 1-(4-(4-bromophenyl)butyl)-1,1,3,3,3-pentamethyldisiloxane (^{MM-Si}Ar—Br)

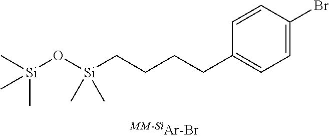 [SMILES: C[Si](C)(C)O[Si](C)(C)CCCCc1ccc(Br)cc1]

1-Bromo-4-(but-3-en-1-yl)benzene (2 g, 9.47 mmol, 1 equiv) was added to a 50-mL round bottom flask along with a magnetic stir bar and Karstedt's catalyst (2-3 drops of a 2 wt % Pt solution in xylenes). The mixture was heated to 50° C. and 1,1,1,3,3-pentamethyldisiloxane (MM′) (1.41 g, 9.47 mmol, 1 equiv) was added dropwise. The reaction mixture was heated for 2 h prior to cooling to ambient temperature. Acetonitrile (2 mL) was added to the mixture, causing a phase separation. The acetonitrile was decanted away from the product and the solvent addition step and decanting was repeated two more times. The resulting colorless product was dried further in vacuo. Yield: 3.10 g, 91.1%. ¹H NMR (400 MHz, CDCl₃) δ 7.38 (d, J=8.3 Hz, 2H), 7.04 (d, J=8.3 Hz, 2H), 2.64-2.48 (m, 2H), 1.66-1.56 (m, 2H), 1.41-1.30 (m, 2H), 0.58-0.48 (m, 2H), 0.05 (s, 9H), 0.03 (s, 6H).

### Intermediate Example 3—Preparation of 3-(4-(4-bromophenyl)butyl)-1,1,1,3,5,5,5-heptamethyltrisiloxane (^{MDM-Si}Ar—Br)

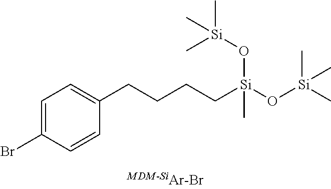 [SMILES: C[Si](C)(C)O[Si](C)(CCCCc1ccc(Br)cc1)O[Si](C)(C)C]

1-Bromo-4-(but-3-en-1-yl)benzene (2 g, 9.47 mmol, 1 equiv) was added to a 50-mL glass vial along with a magnetic stir bar and Karstedt's catalyst (4 drops of 2 wt % in xylenes) inside a fume hood. The mixture was heated to 50° C. with stirring and 1,1,1,3,5,5,5-heptamethyltrisiloxane (MD′M, 2.57 mL, 9.47 mmol, 1 equiv) was added dropwise. The reaction mixture was stirred for 22 h at 50° C. then cooled to ambient temperature. The mixture was diluted with hexanes (4 mL) with stirring. Activated carbon was then added to the mixture with stirring for ˜1 min. The mixture was filtered sequentially through a 0.45 μm syringe filter, followed by filtering through a 0.2 μm syringe filter. The solvent was removed in vacuo. The resulting pale-yellow liquid was then purged with N₂ and stored in a glovebox over 4 Å molecular sieves for at 24 h prior to use. Yield: 3.99 g, 97.1% ¹H NMR (500 MHz, CDCl₃) δ 7.41-7.35 (m, 1H), 7.04 (d, J=8.0 Hz, 1H), 2.56 (t, J=7.7 Hz, 1H), 1.61 (p, J=7.6 Hz, 1H), 1.42-1.30 (m, 1H), 0.53-0.43 (m, 1H), 0.07 (d, J=1.0 Hz, 7H), −0.01 (s, 1H). ¹³C NMR (126 MHz, CDCl₃) δ 141.9, 131.4, 130.3, 119.4, 35.2, 34.9, 22.8, 17.6, 2.0, −0.1.

### Intermediate Example 4—Preparation of 1-(4-(4-bromophenyl)butyl)-butyl-polymethyldisiloxane (^{nBu-PDMS}Ar—Br, dp=10-12)

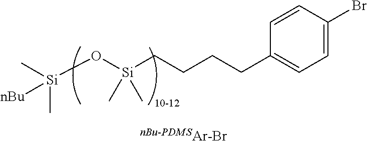

1-Bromo-4-(but-3-en-1-yl)benzene (5.08 g, 24.06 mmol, 1 equiv) was added to a 100-mL round bottom flask along with a magnetic stir bar and Karstedt's catalyst (4-5 drops of a 2 wt % Pt solution in xylenes) inside a fume hood. The mixture was then heated to 50° C. with stirring and MCR-H07 Monohydride-terminated Polydimethysiloxane (Gelest, Inc., DP 10-12, 22.7 g, ˜26.47 mmol, −1.1 equiv) was added dropwise. The reaction mixture heated at 50° C. for 12 h then cooled to ambient temperature. The product was washed with acetonitrile (3×25 mL), then taken up in diethyl ether (4 mL), stirred with activated carbon, and filtered. The volatiles were removed in vacuo, affording a viscous liquid product. Yield: 24.4 g, 95.0%. ¹H NMR (400 MHz, CDCl₃) δ=¹H NMR (400 MHz, CDCl₃) δ 7.38 (d, J=8.3 Hz, 2H), 7.04 (d, J=8.3 Hz, 2H), 2.62-2.51 (m, 2H), 1.67-1.55 (m, 2H), 1.44-1.23 (m, 6H), 0.92-0.83 (m, 3H), 0.61-0.48 (m, 4H), 0.10-0.01 (overlapping, 72H). ¹³C NMR (101 MHz, CDCl₃) δ 141.9, 131.4, 130.3, 119.4, 35.2, 35.2, 26.5, 25.6, 23.0, 18.2, 18.1, 14.0, 1.3, 1.2, 0.3.

### Intermediate Example 5—Preparation of ^{MM-Si}ArPPh₂

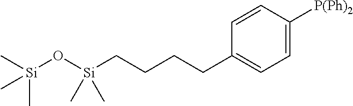

^{MM-Si}Ar—Br (2.080 g, 5.79 mmol, 1 equiv) was added in a nitrogen glove box to a vial along with a magnetic stir bar and diethyl ether (25 mL). The solution was stored at −25° C. for 60 min, then transferred to a vial holder maintained at −25° C. A 2.5 M solution of n-BuLi (2.315 mL, 5.79 mmol, 1 equiv) was added dropwise to the solution and the mixture was stirred for 30 min in the cold vial holder, then returned to the −25° C. freezer for 10 min. Ph₂PCl (1.28 g, 1.04 mL, 5.79 mmol, 1 equiv) was added to the reaction mixture at −25° C. and the resulting pale-yellow mixture was allowed to gradually warm to ambient temperature with continued stirring for 24 h. The volatiles were removed in vacuo and the yellow residue was extracted with pentane, filtered, and concentrated to afford a yellow-orange oil. The product was purified using ISCO chromatography on silica (0 to 50% ethyl acetate in hexanes), and the purified material (2.5 g) was then subjected to supercritical CO₂ using a 25% isopropanol 75% ethyl acetate co-solvent mixture and a bridged ethylene hybrid (BEH) column. The co-solvent percentage gradient was increased from 2% to 5% over a 10 min method (remainder CO₂). Mass directed collection was at 465 based on target compound. ¹H NMR (400 MHz, C₆D₆) δ 7.34-7.01 (m, 4H), 2.62-2.44 (m, 2H), 1.70-1.51 (m, 2H), 1.39-1.24 (m, 2H), 0.61-0.44 (m, 2H), −0.02 (s, 9H), −0.03 (s, 6H). ¹³C NMR (101 MHz, C₆D₆) δ 143.9, 137.8, 137.7, 134.0 (d, J=19.9 Hz), 133.8 (d, J=19.3 Hz), 128.8 (d, J=7.4 Hz), 128.7, 128.6 (d, J=6.8 Hz), 35.6, 35.1, 23.2, 18.4, 2.1, 0.5. ³¹P NMR (162 MHz, CDCl₃) δ −6.2.

### Intermediate Example 6—Preparation of ^{MDM-Si}ArPPh₂

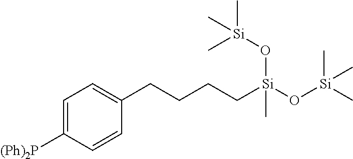

^{MDM-Si}Ar—Br (1.05 g. 2.42 mmol, 1 equiv) was added in a nitrogen glovebox to a 40-mL glass vial along with a magnetic stir bar and THE (8 mL) and the mixture was heated to 60° C. In a separate 7-mL vial, freshly ground magnesium turnings (˜100 mg) were combined with THF (1 mL) and a catalytic amount of iodine (˜2 mg) to form a suspension. The suspension was vigorously stirred until it became colorless, and then added to the solution of ^{MDM-Si}Ar—Br. The resulting product (Grignard reagent) was stirred vigorously at 60° C. for 6 h, then cooled to ambient temperature. 1,4-Dioxane (2 mL) was added to the Grignard reagent and then stirred for 10 min, causing the precipitation of colorless solids. The mixture was then filtered through celite and concentrated to a viscous liquid. The filtrate was combined with diethyl ether (4 mL) and stored at −25° C. for 30 min. Separately, diphenylchlorophosphine (0.401 mL, 2.18 mmol, 0.9 equiv) was combined with diethyl ether (4 mL) and stored at −25° C. for 30 min. This chilled solution of phosphine was then added dropwise to the solution of Grignard reagent at −25° C. After the addition was complete, the reaction mixture was left to slowly warm to ambient temperature with stirring for 20 h. The volatiles were removed in vacuo and the resulting pale-yellow material was extracted with dichloromethane (3×5 mL), filtered through celite, and concentrated to a pale-yellow liquid. The material was purified by ISCO chromatography on silica using 0 to 50% dichloromethane (DCM) in hexanes. Yield: 0.75 g, 57.5%.

¹H NMR (500 MHz, CDCl₃) δ 7.39-7.28 (m, 10H), 7.24 (t, J=8.8 Hz, 2H), 7.16 (d, J=7.7 Hz, 2H), 2.61 (t, J=7.7 Hz, 2H), 1.64 (p, J=7.6 Hz, 2H), 1.41-1.33 (m, 2H), 0.58-0.46 (m, 2H), 0.08 (s, 18H), 0.00 (s, 3H). ¹³C NMR (126 MHz, CDCl₃) δ 143.9, 137.8, 137.8, 134.1, 133.9, 133.9, 133.8, 133.7, 128.9, 128.8, 128.7, 128.6, 128.5, 35.6, 34.9, 22.9, 17.6, 2.0, −0.1. ³¹P NMR (202 MHz, CDCl₃) δ −6.06.

### Intermediate Example 7—Preparation of ^{nBu-PDMS}ArPPh₂

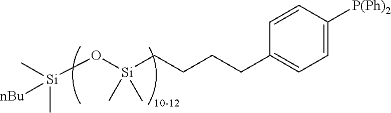

The procedure described for preparing ^{MDM-Si}ArPPh₂ was used except that ^{nBu-PDMS}Ar—Br (1.00 g, 0.80 mmol, 1 equiv) and diphenylchlorophosphine (0.132 mL, 0.72 mmol, 0.9 equiv) were used. Yield: 0.660 g, 70.5%. ¹H NMR (500 MHz, CDCl₃) δ 7.36-7.28 (m, 10H), 7.23 (t, J=7.7 Hz, 2H), 7.16 (d, J=7.8 Hz, 2H), 2.61 (t, J=7.8 Hz, 2H), 1.65 (p, J=7.6 Hz, 2H), 1.46-1.21 (overlapping, 8H), 0.89 (t, J=6.6 Hz, 4H), 0.61-0.49 (m, 4H), 0.13-0.02 (m, 74H). ³¹P NMR (202 MHz, CDCl₃) δ −6.11.

### Intermediate Example 8—Preparation of (^{MM}Ar)₂PPh

The procedure described for preparing ^{MDM-Si}ArPPh₂ was used except that ^{MM-Si}Ar (1.02 g, 2.84 mmol, 1 equiv) and phenyldichlorophosphine (0.193 mL, 1.42 mmol, 0.5 equiv) were used. The material was purified by ISCO chromatography on silica using a gradient of ethyl acetate in hexanes (0-80%). Yield: 0.280 g, 30.0%. ¹H NMR (500 MHz, CDCl₃) δ 1H NMR (400 MHz, CDCl₃) δ 7.37-7.29 (m, 5H), 7.27-7.14 (overlapping multiplets, 8H), 7.19-7.14 (m, 1H), 2.71-2.46 (m, 4H), 1.0-1.60 (m, 4H), 1.51-1.25 (m, 4H), 0.71-0.49 (m, 4H), 0.07 (s, 18H), 0.06 (s, 12H). ³¹P NMR (202 MHz, CDCl₃) δ −6.87.

### Example 1—Preparation of Platinum(II) Oxalate-(^{MM-Si}ArPPh₂)₂

K₂Pt(C₂O₄)₂(OH₂)₂(Pt complex, 0.100 g, 0.22 mmol, 1 equiv) was suspended in distilled water (2.5 mL) in an amber-colored 7-mL screw cap vial. The mixture was heated gently while stirring and briefly sparging with N₂ until the Pt complex dissolved, affording a yellow solution. Separately, Intermediate Example 5 (^{MM-Si}ArPPh₂, 0.310 g, 0.67 mmol, 3 equiv)) was dissolved in 0.5 mL of acetone, then added dropwise to the stirring aqueous solution of the Pt complex and heating was increased to 85° C. The heterogeneous reaction mixture was then capped and stirred vigorously at 85° C. for 24 h. The resulting biphasic reaction mixture contained a distinct yellow-orange layer (top) and nearly colorless layer (bottom). The mixture was allowed to cool to ambient temperature and then diluted with DCM (10 mL) and distilled water (10 mL). The mixture was transferred to a 60-mL vial and shaken. The resulting yellow DCM layer and colorless aqueous layer were allowed to separate. The aqueous layer was then decanted, and the DCM layer was dried over MgSO₄ and filtered. The pale-yellow filtrate was then concentrated to a viscous oil in vacuo. The oil was combined with hexanes (25 mL) and stirred vigorously at ambient temperature for 5 min, causing a nearly colorless solid to precipitate out. The supernatant was decanted, and the colorless solid was washed with additional hexanes (2×25 mL). The resulting solid was then dried under vacuum at ambient temperature. Yield: 0.170 g, 63.0%. ¹H NMR (400 MHz, CDCl₃) δ 7.49-7.28 (m, 16H), 7.23-7.16 (m, 8H), 7.04-6.99 (m, 4H), 2.68-2.49 (m, 4H), 1.64-1.53 (m, 4H), 1.47-1.16 (m, 8H), 0.61-0.49 (m, 4H), 0.05 (s, 18H), 0.04 (s, 12H). ¹³C NMR (101 MHz, CDCl₃) δ 165.9, 147.2, 134.7, 134.7, 134.6, 134.5, 134.4, 134.3, 131.5, 128.7, 128.7, 128.6, 128.5, 128.5, 128.4, 35.7, 34.8, 23.3, 18.3, 2.1, 0.5. ³¹P NMR (162 MHz, CDCl₃) δ 6.99 (t, J=1895.8 Hz).

### Example 2—Preparation of Platinum(II) Oxalate-(^{MDM-Si}ArPPh₂)₂

The preparation and purification of Example 3 was substantially the same as described for the preparation of the compound of Example 1 except that K₂Pt(C₂O₄)₂(OH₂)₂ (150 mg) and Intermediate 6 (^{MDM-Si}ArPPh₂, 2.5 equivalents) were used. Yield: 0.20 g, 44.0%. ¹H NMR (500 MHz, CDCl₃) δ 7.46-7.28 (m, 8H), 7.22-7.16 (overlapping, 8H), 7.01 (d, J=7.8 Hz, 4H), 2.58 (t, J=7.8 Hz, 4H), 1.65-1.53 (m, 4H), 1.44-1.31 (m, 4H), 0.54-0.46 (m, 4H), 0.08 (s, 36H), 0.00 (s, 6H). ¹³C NMR (126 MHz, CDCl₃) δ 165.9, 147.2, 134.9-134.52 (m), 134.4 (t, J=5.4 Hz), 131.5, 128.9-128.6 (m), 128.6-128.4 (m), 35.7, 34.6, 23.1, 17.6, 2.03, −0.10. ³¹P NMR (202 MHz, CDCl₃) δ 6.99 (t, J=1891.2 Hz).

### Example 3—Preparation of Platinum(II) Oxalate-(^{nBu-PDMS}ArPPh₂)₂

The preparation and purification of Example 3 was substantially the same as described for the preparation of the compound of Example 1 except that K₂Pt(C₂O₄)₂(OH₂)₂ (100 mg) and Intermediate 7 (^{nBu-PDMS}ArPPh₂, 2.5 equivalents) were used. Yield: 0.24 g, 41.0%. ¹H NMR (400 MHz, CDCl₃) δ 7.43-7.28 (m, 16H), 7.23-7.16 (m, 8H), 7.04-6.99 (m, 4H), 2.64-2.48 (m, 4H), 1.67-1.58 (m, 4H), 1.41-1.23 (m, 16H), 0.92-0.83 (m, 8H), 0.59-0.50 (m, 8H), 0.12-0.00 (m, 74H). ³¹P NMR (162 MHz, CDCl₃) δ 7.02 (t, J=1888.0 Hz).

### Example 4—Preparation of Platinum(II) Oxalate-(^{MM}Ar)₂PPh

The preparation and purification of Example 4 was substantially the same as described for Example 1 except that 75 mg of K₂Pt(C₂O₄)₂(OH₂)₂ and 2.2 equivalents of (^{MM}Ar)₂PPh ligand were used. Yield: 0.120 g, 44.4%. ¹H NMR (400 MHz, CDCl₃) δ 7.49-7.28 (m, 10H), 7.23-7.07 (m, 8H), 7.07-6.90 (m, 8H), 2.81-2.39 (m, 8H), 1.86-1.46 (m, 8H), 1.46-1.23 (m, 8H), 0.66-0.45 (m, 8H), 0.16-−0.10 (overlapping resonances, 60H). ³¹P NMR (162 MHz, CDCl₃) δ 6.32 (t, J=1875.7 Hz).

### Comparative Example 1—Preparation of Triphenylphosphine Platinum(II) Oxalate

Crystalline K₂Pt(C₂O₄)₂(OH₂)₂ (0.120 g, 0.27 mmol, 1 equiv), a magnetic stir bar, and distilled water (3-4 mL) were combined in an uncapped, amber-colored vial in a fume hood. The mixture was heated with rapid stirring to dissolve the platinum complex. A solution of triphenylphosphine (0.140 g, 0.53 mmol, 2 equiv) in acetone (3-4 mL) was added to the solution of the platinum complex prior to the targeted set temperature of 80° C. with continued stirring. After reaching 80° C., the reaction mixture was stirred at that temperature for 2 h, then cooled to ambient temperature. The product was then collected on filter, washed with water (3×10 mL), then suspended in ethanol (˜18 mL). The colorless suspension was then heated to boiling to fully solubilize the colorless material. The hot ethanol extract was filtered, and the filtrate was allowed to slowly cool to ambient temperature overnight in a loosely capped amber scintillation vial. The next day, colorless crystals were collected, rinsed with ethanol (2 mL) and then dried. The crystals were stored in an amber scintillation vial at ambient temperature. Yield: 115 mg, 53.3%. Identity of the target compound was confirmed by comparison to data reported in Organometallics, 1985, 4, 647. ¹H NMR (500 MHz, CDCl₃) δ 7.46-7.35 (m), 7.28-7.18 (m). ¹³C NMR (126 MHz, CDCl₃) δ 165.7, 134.4, 131.5, 128.5. ³¹P NMR (202 MHz, CDCl₃) δ 7.7.

### UV Hydrosilylation Studies

Terminal divinyl siloxane (CAS No: 68083-19-2, DP=9-10, 0.85 g, 1 equiv wrt Si-vinyl), Terminal mono-functional Si—H siloxane (CAS No: 1038821-58-7, DP=10-12, 1.86 g, 2 equiv wrt Si—H) and the L₂Pt(oxalate) stock solution (where L is the phosphine ligand) were added to an aluminum pan and thoroughly mixed. An aliquot of the mixture (100 μL) was removed prior to UV irradiation and combined with 0.5 μL of C₆D₆ and mesitylene (10 μL) as an external standard. The contents of the aluminum dish were then irradiated for 300 s at a time with broadband 200-800 nm light provided by a Uvitron UV chamber set to 100% intensity. After every 300 s of irradiation, a measured aliquot (100 μL) of the contents of the aluminum pan was removed and an NMR spectroscopic sample was prepared by combining the aliquot with 0.5 μL C₆D₆ and a measured amount of mesitylene (10 μL) as an external standard. This process was repeated until all the vinyl siloxane resonances (as determined by ¹H NMR spectroscopy) were consumed or the total irradiation time reached 2700s (45 min). Percent conversion was measured by the integration of resonances attributable to the Si-vinyl protons in the siloxane starting material versus the aryl protons corresponding to the mesitylene standard.

### PDMS Solubility Measurement

Vinyl siloxane (0.85 g, 1 equiv wrt Si-vinyl), SiH siloxane (1.86 g, 2 equiv wrt Si—H) and L₂Pt(oxalate) stock solution were added to an aluminum pan and thoroughly mixed. The entire mixture was visually inspected for phase heterogeneity.

### Dark Stability Measurement

Vinyl siloxane (0.85 g, 1 mmol, 1 equiv), SiH siloxane (1.86 g, 2 mmol, 2 equiv), and a 0.01 M Pt stock solution in dichloromethane (7 uL for 5 ppm Pt catalyst) were added to an amber-colored vial and thoroughly mixed. A 100-μL aliquot was removed from this initial mixture (prior to any heating) and a ¹H NMR spectroscopic sample also containing 10 μL of mesitylene in C₆D₆ was prepared, analyzed, and recorded as “Tₒ” (0 min). The mixture of siloxane materials and catalyst was then separated into two amber vials. The first of the two vials was heated at 50° C. for 24 h in the dark and the second vial was kept at ambient temperature for 7 d in the dark. After each of these experiments (24 h at 50° C. or 7 d at ambient temperature) NMR spectroscopic samples were prepared and analyzed by ¹H NMR spectroscopy (0.5 mL C₆D₆, 10 uL mesitylene). Conversion was determined by integration of the mesitylene external standard aryl protons relative the Si-vinyl protons of the Si-vinyl starting material.

Table 1 illustrates the solubility of the catalyst in PDMS (PDMSₛₒₗ); the dark stability of the mixtures at ambient temperature for 7 d (Dark RT); the dark stability of the mixtures at 50° C. for 24 h (Dark 50° C.); the UV conversion to the desired products at 5 min (UVs); and at 15 min (UV₁₅). The concentration of Pt for each test was 5 ppm.

TABLE 1
Dark Stability and UV-Initiated Hydrosilylation Conversion

| Ex No. | PDMSₛₒₗ | Dark RT | Dark 50° C. | UV5 | UV 15 |
|---|---|---|---|---|---|
| Comp. 1 | Insoluble | <5% | <5% | 12% | 61% |
| Ex. 1 | Moderate | <5% | <5% | 20% | >99% |
| Ex. 2 | Moderate | <5% | 20% | 15% | >99% |
| Ex. 3 | Fully | <5% | <5% | 84% | >99% |
| Ex. 4 | Fully | <5% | <5% | 13% | 90% |

The data illustrate that the use of a Pt(II) oxalate-phenylsiloxane phosphine complex resulted in the complete hydrosilylation of the silane and vinylsiloxane starting materials within 15 min. In contrast, the comparative Pt(II) oxalate-triphenylphosphine complex resulted in incomplete conversion even after 30 min of UV exposure at ambient temperature. The tested compounds were also found to exhibit good to excellent PDMS solubility, relatively low volatility, and acceptable retention of dark stability.

1. A platinum(II) oxalate compound of the following formula: 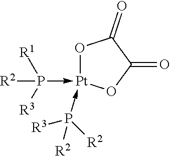
where R¹ is phenyl(CH₂)ₙR⁴, where n is from 3 to 30; each R² is independently C₁-C₁₀-alkyl, phenyl, or phenyl(CH₂)ₙR⁴; each R³ is independently C₁-C₁₀-alkyl, phenyl, phenyl(CH₂)ₙR⁴, or each R³, together with the phosphorus atoms to which they are attached, form a diphosphine; each R⁴ is either: 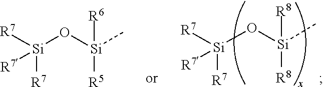
where R⁵ is C₁-C₁₀-alkyl or phenyl; R⁶ is C₁-C₁₀-alkyl or phenyl or O—Si(CH₃)₃; each R⁷ is independently C₁-C₁₀ alkyl or phenyl; R^{7′} is C₁-C₁₀ alkyl; and each R⁸ is independently C₁-C₁₀-alkyl or phenyl; x is from 2 to 250; and the dotted line represents the point of attachment to a CH₂ radical.

2. The platinum(II) oxalate compound of claim 1 wherein R⁵ is C₁-C₆-alkyl or phenyl; R⁶ is C₁-C₆-alkyl or phenyl or O—Si(CH₃)₃; each R⁷ is independently C₁-C₆ alkyl; R^{7′} is C₁-C₆ alkyl; each R⁸ is independently C₁-C₆-alkyl or phenyl; and the dotted line represents the point of attachment to a CH₂ radical; n is from 4 to 20; and x is from 2 to 50.

3. The platinum(II) oxalate compound of claim 2 where each R⁸ and each R⁵ are independently methyl or phenyl; R⁶ is methyl, phenyl, or O—Si(CH₃)₃; R^{7′} is methyl; and x is from 2 to 20.

4. The platinum(II) oxalate compound of claim 2 wherein P(R¹R²R³) or P(R²R²R³) or both are selected from the group consisting of: 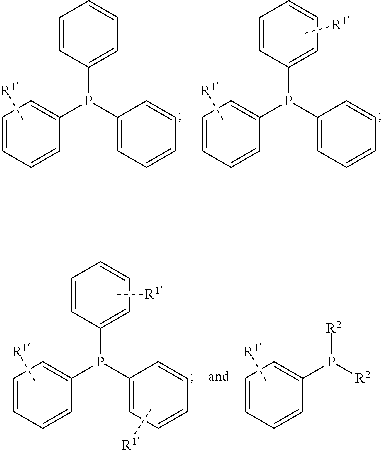
where each R^{1′} is independently (CH₂)ₙR⁴.

5. The platinum(II) oxalate compound of claim 3 wherein P(R¹R²R³) or P(R²R²R³) or both are selected from the group consisting of: 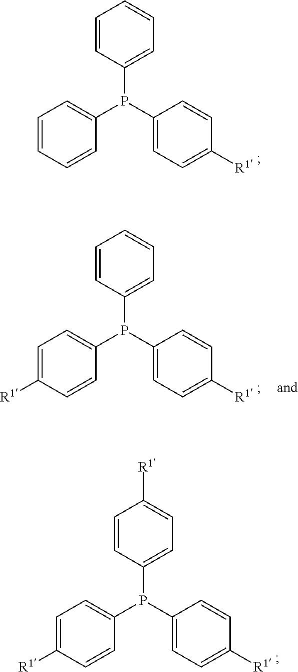
where each R^{1′} is independently (CH₂)ₙR⁴.

6. The platinum(II) oxalate compound of claim 3 wherein P(R¹R²R³) and P(R²R²R³) form diphosphines selected from the group consisting of: 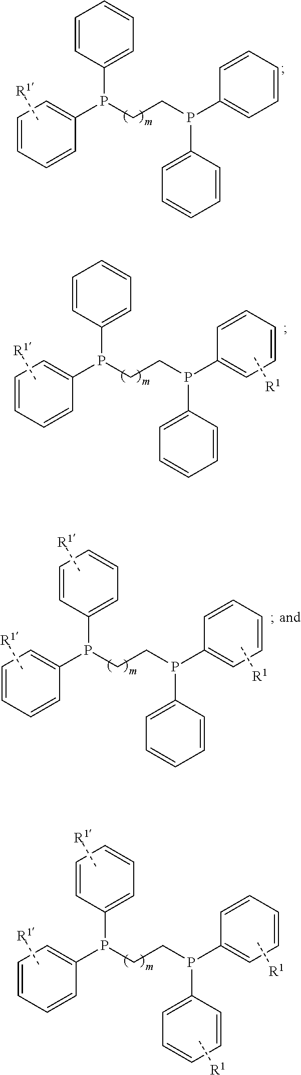
where m is 0, 1, 2, 3, 4, or 5; and each R^{1′} is independently (CH₂)ₙR⁴.

7. The platinum(II) oxalate compound of claim 6 where m is 1; and each R^{1′} is selected from the group consisting of: 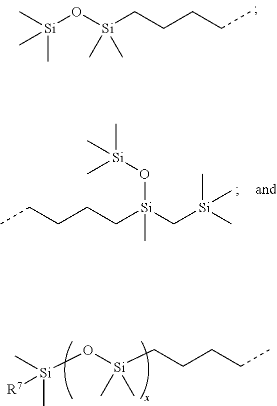
where the dotted line is the point of attachment to the phenyl ring; and each R⁷ is independently C₁-C₆-alkyl.

8. The platinum(II) oxalate compound of claim 5 where each R^{1′} is selected from the group consisting of: 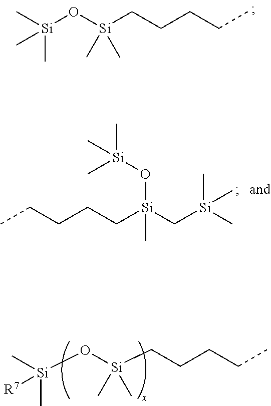
where the dotted line is the point of attachment to the phenyl ring; and each R⁷ is independently C₁-C₆-alkyl.

9. The platinum(II) oxalate compound of claim 1 which is selected from the group consisting of platinum(II) oxalate-(^{MM-Si}ArPPh₂)₂, platinum(II) oxalate-(^{MDM-Si}ArPPh₂)₂; platinum(II) oxalate-(^{nBu-PDMS}ArPPh₂)₂; and platinum(II) oxalate-((^{MM}Ar)₂PPh)₂.

10. A composition comprising a vinyl-functionalized siloxane, an Si—H containing siloxane, and a catalytic amount of the platinum(II) oxalate compound of claim 1.
